(19) United States
(12) Patent Application Publication
(10) Pub. No.: US 2025/0355742 A1
(43) Pub. Date: Nov. 20, 2025

(54) PREVENTING FIRST PAGE READ ERRORS

(71) Applicant: Micron Technology, Inc., Boise, ID (US)

(72) Inventors: Yu-Chung Lien, San Jose, CA (US); Tingjun Xie, Milpitas, CA (US); Daniel Zhang, Milpitas, CA (US); Zhenming Zhou, San Jose, CA (US)

(21) Appl. No.: 19/191,962

(22) Filed: Apr. 28, 2025

Related U.S. Application Data
(60) Provisional application No. 63/647,375, filed on May 14, 2024.

(51) Int. Cl. G06F 11/07

(52) U.S. Cl. CPC G06F 11/0757; G06F 11/073

(57) ABSTRACT

The present disclosure configures a memory sub-system controller to perform a first page read scan in a memory sub-system. The controller determines that a condition to prevent first page read errors has been met. The controller, in response to determining that the condition to prevent the first page read errors has been met, selects a first portion of a set of memory components. The controller determines whether the first portion corresponds to single level cell (SLC) usage and selectively performs one or more memory operations to prevent first page read errors associated with the first portion based on whether the first portion corresponds to single level cell (SLC) usage.

### PRIORITY APPLICATION

This application claims the benefit of priority to U.S. Provisional Application Ser. No. 63/647,375, filed May 14, 2024, which is incorporated herein by reference in its entirety.

### TECHNICAL FIELD

This disclosure relates generally to memory sub-systems and, more specifically, to providing adaptive media management for memory components, such as memory dies.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an example computing environment including a memory sub-system, in accordance with some examples.

FIG. 2 is a block diagram of an example media operations manager, in accordance with some examples.

FIG. 3 is a block diagram of an example of a first page read scan component in the memory sub-system, in accordance with some examples.

FIGS. 4 and 5 are flow diagrams of example methods to selectively perform first page read scan operations, in accordance with some examples.

FIG. 6 is a block diagram illustrating a diagrammatic representation of a machine in the form of a computer system within which a set of instructions can be executed for causing the machine to perform any one or more of the methodologies discussed herein, in accordance with some examples.

### DETAILED DESCRIPTION

The present disclosure configures a system component, such as a memory sub-system controller, to selectively perform first page read scan operations on one or more components in a memory sub-system. The memory sub-system controller can, during a first page read scan, determine whether a particular portion being scanned (e.g., a memory block) corresponds to single-level cell (SLC) usage or not (e.g., corresponds to multi-level cell (MLC), tri-level cell (TLC), or quad-level cell (QLC) usage). Based on this determination, the memory sub-system controller can perform or prevent performing one or more memory operations (e.g., ganged reset read or dummy read operations) on the particular portion. This avoids performing such memory operations on all memory blocks regardless of the storage type or usage type which reduces power consumption and latency. This improves the overall efficiency of operating the memory sub-system.

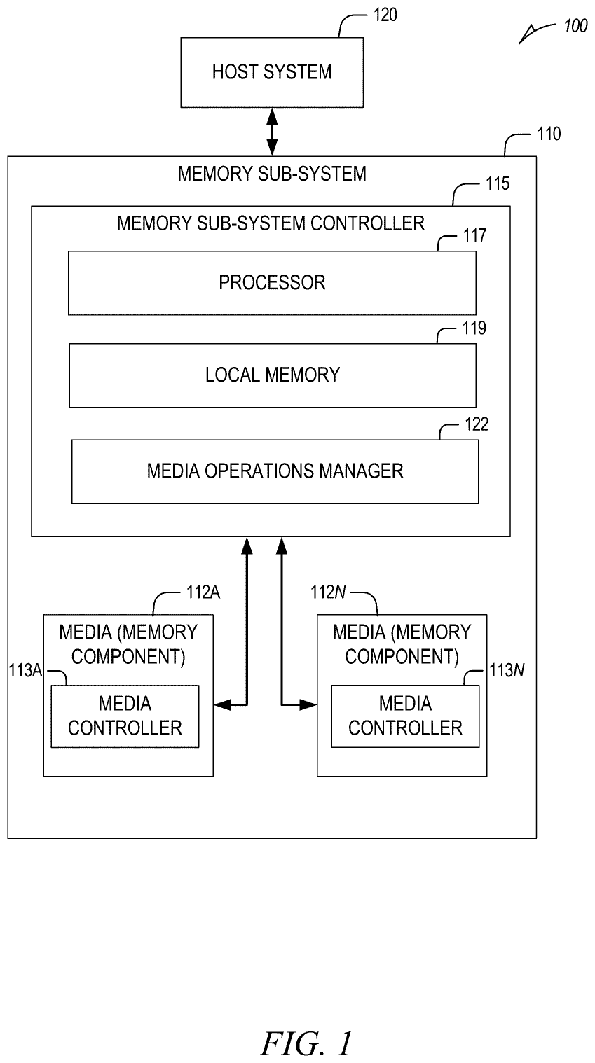

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices (e.g., memory dies or planes across multiple memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data”.

The memory sub-system can initiate media management operations, such as a write operation, on host data that is stored on a memory device. In some examples, firmware of the memory sub-system may re-write previously written host data from a location on a memory device to a new location as part of garbage collection management operations. The data that is re-written, for example as initiated by the firmware, is hereinafter referred to as “garbage collection data”. “User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management, different near miss error correction code (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. Near-miss ECC refreshes all data read by the application that exceeds a configured threshold of errors. Dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., NAND devices), each plane is comprised of a set of physical blocks. For some memory devices, blocks are the smallest area that can be erased. Such blocks can be referred to or addressed as logical units (LUN). Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which is a raw memory device combined with a local embedded controller for memory management within the same memory device package.

There are challenges in efficiently managing or performing media management operations on typical memory devices. NAND flash memory devices are organized into blocks and pages, where each block contains a number of pages. In certain cases, first page read issues can arise when a page, block or portion of the memory components is read for the first time. Particularly, in certain memory sub-systems, the first time a page, block or portion is read (e.g., after a period of time, such as one or more minutes since the last time the page, block or portion was read elapses), the voltage threshold of the page, block or portion shifts from one state to another. For example, after the period of time elapses, the charges stored in the page, block or portion can shift from the transient state to a stable state. This is usually the case when the data is stored in the page, block or portion using MLC, QLC, or TLC storage type. In order to properly read the data from the page, block or portion, a different voltage threshold may need to be applied depending on the state in which the charges are stored.

To avoid having to change the threshold voltage that is applied based on whether the page is read for the first time (after the period of time elapses) or not, conventional memory sub-systems perform a first page read scan operation. The first page read scan operation usually involves applying a ganged reset operation or dummy read operation across all portions of the memory components. A “ganged reset” operation is an operation that resets multiple components within a system simultaneously, such as by moving the state of the charges from the stable state to the transient state to enable read operations to be executed properly. In the case of NAND flash memory, a ganged reset read operation may involve resetting the read circuitry of multiple pages or even the entire block before attempting to read the first page again. This reset operation is intended to clear any residual charges or states that might be causing read errors without sensing the data or charges that are stored in the pages. A dummy read operation is an operation that reads the charges stored in the pages without returning the data to a calling process. However, not all memory usages are prone to first page read issues. As such, applying the first page read scan operations to all the portions regardless of the memory usage type wastes power, adds latency, and causes the memory sub-system to operate inefficiently. This creates significant inefficiencies and wastes resources.

The present disclosure addresses the above and other deficiencies by providing a memory controller that can selectively perform first page read scan operations on one or more components in a memory sub-system. The memory sub-system controller can, during a first page read scan, determine whether a particular portion being scanned (e.g., a memory block) corresponds to SLC usage or not (e.g., corresponds to MLC usage, TLC usage, or QLC usage). Based on this determination, the memory sub-system controller can perform or prevent performing one or more memory operations (e.g., ganged reset read or dummy read operations) on the particular portion. This avoids performing such memory operations on all memory blocks regardless of the storage type or usage type which reduces power consumption and latency. This improves the overall efficiency of operating the memory sub-system.

In some examples, the memory controller determines that a condition to prevent first page read errors has been met. The controller, in response to determining that the condition to prevent the first page read errors has been met, selects a first portion of the set of memory components and determines whether the first portion corresponds to SLC usage. The controller selectively performs one or more memory operations to prevent first page read errors associated with the first portion based on whether the first portion corresponds to SLC usage. In some cases, the memory sub-system includes a three-dimensional (3D) NAND memory.

The controller accesses a timer associated with performing the one or more memory operations to prevent first page read errors. The controller determines that the timer transgresses a threshold value. The controller determines that the condition has been met in response to determining that the timer transgresses the threshold value. In some cases, the threshold value includes a period of one or more minutes.

In some examples, the controller determines that the first portion corresponds to SLC usage. In such cases, the controller skips performing the one or more memory operations on the first portion in response to determining that the first portion corresponds to SLC usage. The controller determines that the first portion fails to correspond to SLC usage. In such cases, the controller performs the one or more memory operations on the first portion in response to determining that the first portion fails to correspond to SLC usage.

The controller performs a ganged reset read operation on the first portion as the one or more memory operations. In some cases, the ganged reset read operation includes ramping up one or more word lines (WLs) without sensing in the first portion. In some examples, the controller performs a dummy read operation on the first portion as the one or more memory operations.

In some cases, the controller selects a second portion of the set of memory components. The controller determines whether the second portion corresponds to the SLC usage and selectively performs the one or more memory operations to prevent first page read errors associated with the second portion based on whether the second portion corresponds to SLC usage.

The controller performs a ganged reset read operation on the second portion in response to determining that the second portion fails to correspond to the SLC usage. The controller skips performing the ganged reset read operation on the first portion in response to determining that the first portion corresponds to the SLC usage. In some cases, the second portion corresponds to TLC or QLC usage. The controller initiates performing a first page read errors scan operation in response to determining that the condition has been met. The controller transitions a voltage threshold of the first portion from a stable state to a transient state in response to selectively performing the one or more memory operations. In some cases, the voltage threshold of (or charges stored by) the first portion returns to the stable state after a period of time elapses.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples. The memory sub-system 110 can include media, such as memory components 112A to 112N (also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies). Each memory die can include a plurality of planes in which data can be stored or programmed.

In some examples, the first memory component 112A including (a WL, a WLG, a block, or page of the first memory component 112A), or group of memory components including the first memory component 112A can be associated with a first reliability (capability) grade, value, measure, or lifetime PEC. The terms “reliability grade,” “value” and “measure” are used interchangeably throughout and can have the same meaning. The second memory component 112N (a WL, a WLG, a block, or page of the second memory component 112N) or group of memory components including the second memory component 112N can be associated with a second reliability (capability) grade, value, measure, or lifetime PEC. In some examples, each memory component 112A to 112N can store respective configuration data that specifies the respective reliability grade and lifetime PEC and current PEC. In some examples, a memory or register can be associated with all of the memory components 112A to 112N and can store a table that maps different groups, bins or sets of the memory components 112A to 112N to respective reliability grades, lifetime PEC values, and/or current PEC values.

In some examples, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some examples, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL), a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120.

The memory components 112A to 112N can include any combination of the different types of non-volatile memory components and/or volatile memory components. An example of non-volatile memory components includes a negative-and (NAND)-type flash memory and/or a 3D NAND flash memory. Each of the memory components 112A to 112N can include one or more arrays of memory cells such as single-level cells (SLCs) or multi-level cells (MLCs) (e.g., TLCs or QLCs). In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory. In some examples, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), negative-or (NOR) flash memory, electrically erasable programmable read-only memory (EEPROM), and a cross-point array of non-volatile memory cells.

A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages or blocks that can refer to a unit of the memory component 112 used to store data. For example, a single first row that spans a first set of the pages or blocks of the memory components 112A to 112N can correspond to or be grouped as a first block stripe and a single second row that spans a second set of the pages or blocks of the memory components 112A to 112N can correspond to or be grouped as a second block stripe.

The memory sub-system controller 115 can communicate with the memory components 112A to 112N to perform memory operations such as reading data, writing data, or erasing data at the memory components 112A to 112N and other such operations. The memory sub-system controller 115 can communicate with the memory components 112A to 112N to perform various memory management operations, such as different scan rates, different scan frequencies, different wear leveling, different read disturb management, garbage collection operations, different near miss ECC operations, first page read scan, and/or different dynamic data refresh.

The memory sub-system controller 115 can include hardware such as one or more integrated circuits and/or discrete components, a buffer memory, or a combination thereof. The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some embodiments, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another example of the present disclosure, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive commands or operations from the host system 120 and can convert the commands or operations into instructions or appropriate commands to achieve the desired access to the memory components 112A to 112N. In some examples, the commands or operations received from the host system 120 can specify configuration data for the memory components 112A to 112N. The configuration data can describe the lifetime PEC values and/or reliability grades associated with different groups of the memory components 112A to 112N and/or different WLs, WLGs, and/or blocks within each of the memory components 112A to 112N.

The memory sub-system controller 115 can be responsible for other memory management operations, such as wear leveling operations, garbage collection operations, error detection and error-correcting code (ECC) operations, encryption operations, caching operations, first page read scan operations, and address translations. The memory sub-system controller 115 can further include host interface circuitry to communicate with the host system 120 via the physical host interface. The host interface circuitry can convert the commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N.

The memory devices can be raw memory devices (e.g., NAND), which are managed externally, for example, by an external controller (e.g., memory sub-system controller 115). The memory devices can be managed memory devices (e.g., managed NAND), which is a raw memory device combined with a local embedded controller (e.g., local media controllers) for memory management within the same memory device package. Any one of the memory components 112A to 112N can include a media controller (e.g., media controller 113A and media controller 113N) to manage the memory cells of the memory component (e.g., to perform one or more memory management operations), to communicate with the memory sub-system controller 115, and to execute memory requests (e.g., read or write) received from the memory sub-system controller 115.

The memory sub-system controller 115 can include a media operations manager 122. The media operations manager 122 can be configured to determine that a condition to prevent first page read errors has been met. The media operations manager 122, in response to determining that the condition to prevent the first page read errors has been met, selects a first portion of a set of memory components. The media operations manager 122 determines whether the first portion corresponds to SLC usage and selectively performs one or more memory operations to prevent first page read errors associated with the first portion based on whether the first portion corresponds to SLC usage.

In some examples, the media operations manager 122 can comprise logic (e.g., a set of transitory or non-transitory machine instructions, such as firmware) or one or more components that causes the media operations manager 122 to perform operations described herein. The media operations manager 122 can comprise a tangible or non-tangible unit capable of performing operations described herein. Further details with regards to the operations of the media operations manager 122 are described below.

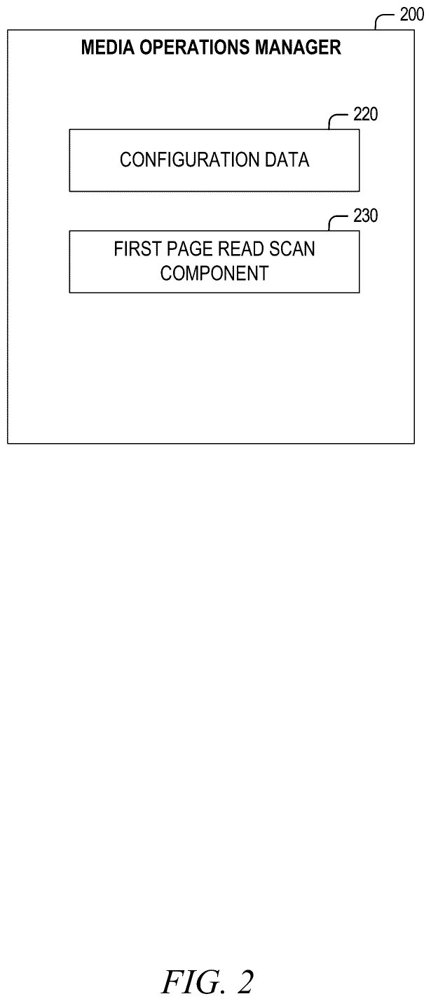

FIG. 2 is a block diagram of an example media operations manager 200 (corresponding to media operations manager 122), in accordance with some examples. As illustrated, the media operations manager 200 includes configuration data 220 and a first page read scan component 230. For some cases, the media operations manager 200 can differ in components or arrangement (e.g., less or more components) from what is illustrated in FIG. 2.

The configuration data 220 accesses and/or stores configuration data associated with the memory components 112A to 112N. In some examples, the configuration data 220 is programmed into the media operations manager 200. For example, the media operations manager 200 can communicate with the memory components 112A to 112N to obtain the configuration data and store the configuration data 220 locally on the media operations manager 122. In some examples, the media operations manager 122 communicates with the host system 120. The host system 120 receives input from an operator or user that specifies parameters including lifetime PEC values of different WLs, WLGs, bins, groups, blocks, block stripes, memory dies and/or sets of the memory components 112A to 112N. The media operations manager 122 receives configuration data from the host system 120 and stores the configuration data in the configuration data 220.

The configuration data 220 can store parameters for controlling when first page read scan operations are performed. For example, the configuration data 220 can store a threshold that is used to compare with a timer representing an elapsed time since the first page read scan operations were performed. In some cases, the threshold is set to one or more minutes but can be dynamically adjusted or programmatically adjusted based on commands from the host system 120. The configuration data 220 can store configuration information indicating a type of memory operation to perform each time the first page read scan operations are performed. For example, the configuration data 220 can store an indication of whether to perform a ganged reset operation or a dummy read operation. In some cases, in one iteration of the first page read scan operations, the ganged reset operation is performed. Then, in a subsequent iteration of the first page read scan operations, the dummy read operation is performed.

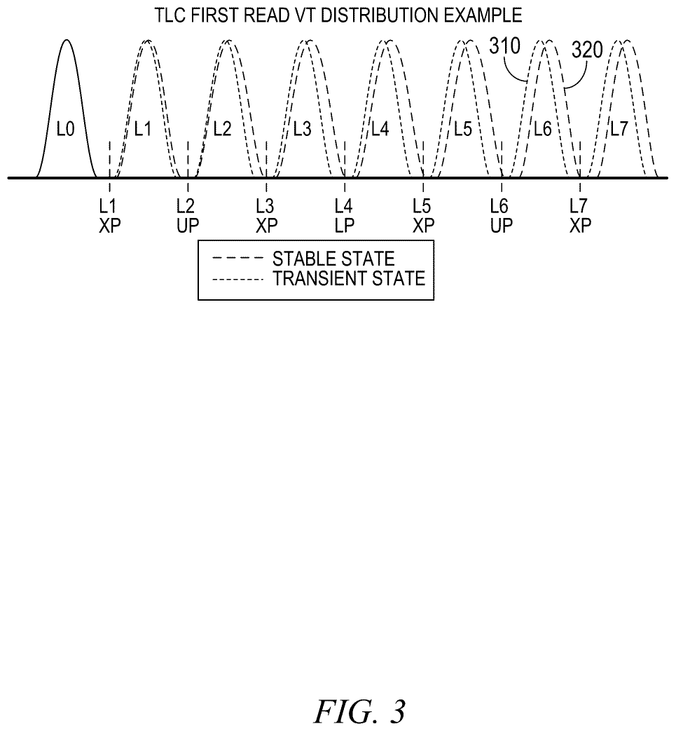

The first page read scan component 230 can be used to selectively perform ganged reset or dummy read scan operations (or any other suitable operation) on one or more portions of the set of memory components 112A to 112N based on a memory storage usage type of the one or more portions. Specifically, the first page read scan component 230 can perform an operation periodically on the one or more portions to keep the charges stored by the one or more portions in a transient state to improve read operations. For example, as shown in FIG. 3, over time (e.g., after more than one or more minutes) charges stored in a portion of the set of memory components 112A to 112N can shift from a transient state 310 to the stable state 320. Read data stored in such portions using a threshold voltage corresponding to the transient state when the data is in the stable state can result in increased read errors. As such, one or more memory operations (e.g., dummy read or ganged read) operations can be performed to move the charges from the stable state 320 to the transient state 310.

In some examples, the first page read scan component 230 accesses the configuration data 220 to obtain a timer threshold. The first page read scan component 230 can reset a timer each time the first page read scan operations are performed. The first page read scan component 230 can compare the timer to the timer threshold. In response to determining that the timer has transgressed the timer threshold, the first page read scan component 230 determines that a condition to prevent first page read errors has been met. In some cases, other conditions can be used to control when the first page read scan operations are performed, such as after a certain number of reads are performed, when a certain temperature is reached by the memory sub-system 110, or any other suitable condition. In some cases, the timer threshold that is obtained can be based on the current temperature of the memory sub-system 110. For example, a higher timer threshold can be used when a temperature of the memory sub-system 110 falls below a temperature threshold and a lower timer threshold can be used otherwise. In this way, the first page read scan operations can be performed more frequently at higher temperatures.

In some examples, the first page read scan component 230 determines that the condition for performing the first page read scan operations has been met. In response, the first page read scan component 230 selects a first portion of the set of memory components 112A to 112N. For example, the first page read scan component 230 selects a first block or page as the first portion. The first page read scan component 230 determines a storage or memory type used to store data in the first portion. For example, the first page read scan component 230 determines whether the first portion is associated with SLC usage or other usage (e.g., MLC, TLC, and/or QLC). In response to determining that the first portion corresponds to SLC usage, the first page read scan component 230 prevents or skips performing the one or more memory operations (e.g., the ganged reset or dummy read operations) on the first portion.

The first page read scan component 230 then selects a second portion of the set of memory components 112A to 112N. For example, the first page read scan component 230 selects a second block or page as the second portion. The first page read scan component 230 determines a storage or memory type used to store data in the second portion. For example, the first page read scan component 230 determines whether the second portion is associated with SLC usage or other usage (e.g., MLC, TLC, and/or QLC). In response to determining that the second portion fails to correspond to SLC usage (e.g., the second portion corresponds to TLC usage), the first page read scan component 230 performs the one or more memory operations (e.g., the ganged reset or dummy read operations) on the second portion.

The first page read scan component 230 determines increments of a portion counter (e.g., a block counter) after scanning (e.g., performing or skipping performing the ganged reset or dummy read operations) a particular portion of the set of memory components 112A to 112N. The first page read scan component 230 determines whether the portion counter corresponds to a last portion (e.g., last block or last page) of the set of memory components 112A to 112N. If not, the first page read scan component 230 repeats the above operations to selectively perform the ganged reset or dummy read operations on the portion identified by the portion counter. If the portion counter corresponds to the last portion (meaning all portions of the set of memory components 112A to 112N) have been scanned, the first page read scan component 230 completes performing the first page read scan operations and clears the timer representing the amount of time that elapsed since the first page read scan operations were last performed.

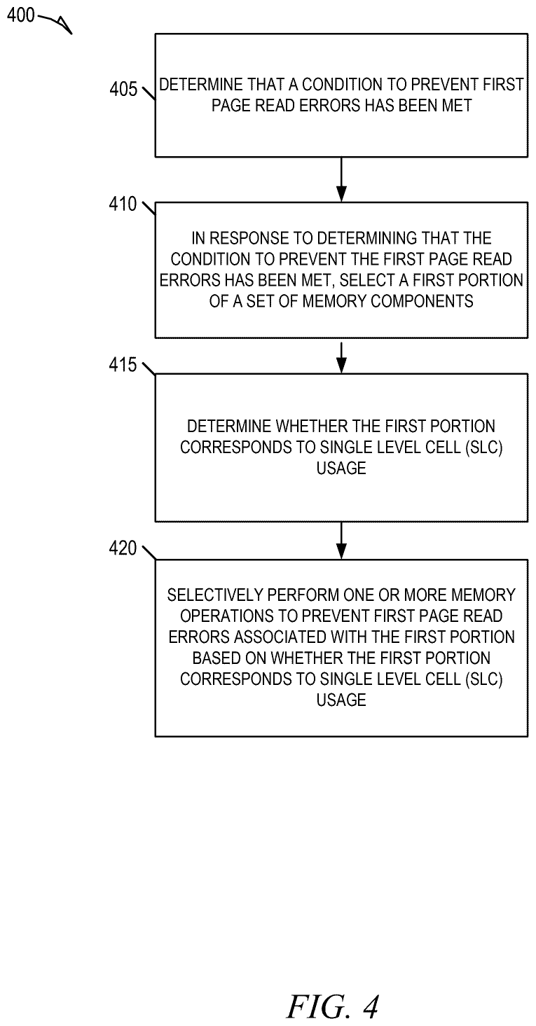

FIG. 4 is a flow diagram of an example method 400 to selectively perform first page read scan operations, in accordance with some examples. The method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 400 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every examples. Other process flows are possible.

Referring now to FIG. 4, the method (or process) 400 begins at operation 405, with a media operations manager 122 of a memory sub-system (e.g., memory sub-system 110) determining that a condition to prevent first page read errors has been met. Then, at operation 410, the media operations manager 122 in response to determining that the condition to prevent the first page read errors has been met, selects a first portion of a set of memory components and determines whether the first portion corresponds to SLC usage at operation 415. At operation 420, the media operations manager 122 selectively performs one or more memory operations to prevent first page read errors associated with the first portion based on whether the first portion corresponds to SLC usage.

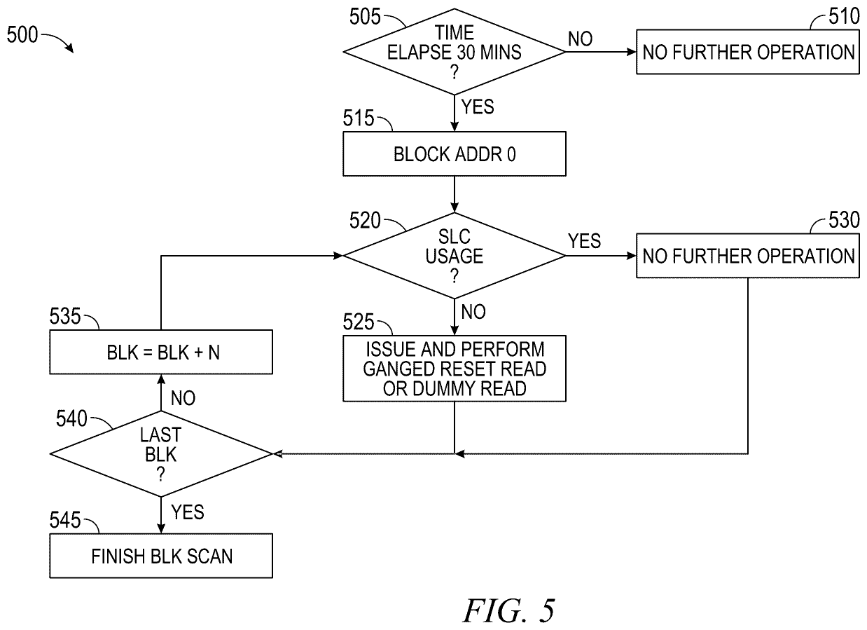

FIG. 5 is a flow diagram of an example method 500 to selectively perform first page read scan operations, in accordance with some examples. The method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 500 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every examples. Other process flows are possible.

Referring now to FIG. 5, the method (or process) 500 begins at operation 505, with a media operations manager 122 of a memory sub-system (e.g., memory sub-system 110) determining whether a timer has reached a threshold time. If so, the media operations manager 122 performs operation 515 and, if not, the media operations manager 122 performs operation 510 where the media operations manager 122 continues comparing the timer to the threshold (e.g., returns to performing operation 505). At operation 515, the media operations manager 122 selects a first portion of the set of memory components 112A to 112N, such as a portion corresponding to block address 0. The media operations manager 122 determines whether the selected portion corresponds to SLC usage at operation 520. If so, the media operations manager 122 performs operation 530 where a ganged read or dummy read operation is skipped from being performed on the selected portion. If not, the media operations manager 122 performs operation 525 where the ganged read or dummy read operation is performed on the selected portion. Then, the media operations manager 122 determines whether the selected portion corresponds to the last portion (e.g., the last block or page) at operation 540.

In response to determining that the selected portion does not correspond to the last portion, the media operations manager 122 performs operation 535 where a portion counter is incremented in response to determining that the selected portion fails to correspond to the last portion. In response to determining that the selected portion corresponds to the last portion, the media operations manager 122 completes performing the first page read scan at operation 545.

In view of the disclosure above, various examples are set forth below. It should be noted that one or more features of an example, taken in isolation or combination, should be considered within the disclosure of this application.
Example 1: A system comprising: a set of memory components of a memory sub-system; and at least one processing device operatively coupled to the set of memory components, the at least one processing device being configured to perform operations comprising: determining that a condition to prevent first page read errors has been met; in response to determining that the condition to prevent the first page read errors has been met, selecting a first portion of the set of memory components; determining whether the first portion corresponds to single level cell (SLC) usage; and selectively performing one or more memory operations to prevent first page read errors associated with the first portion based on whether the first portion corresponds to single level cell (SLC) usage.
Example 2. The system of Example 1, wherein the memory sub-system comprises a three-dimensional (3D) NAND memory.
Example 3. The system of any one of Examples 1-2, the operations comprising: accessing a timer associated with performing the one or more memory operations to prevent first page read errors; determining that the timer transgresses a threshold value; and determining that the condition has been met in response to determining that the timer transgresses the threshold value.
Example 4. The system of Example 3, wherein the threshold value comprises a period of one or more minutes.
Example 5. The system of any one of Examples 1-4, the operations comprising: determining that the first portion corresponds to SLC usage; and skipping performing the one or more memory operations on the first portion in response to determining that the first portion corresponds to SLC usage.
Example 6. The system of any one of Examples 1-5, the operations comprising: determining that the first portion fails to correspond to SLC usage; and performing the one or more memory operations on the first portion in response to determining that the first portion fails to correspond to SLC usage.
Example 7. The system of Example 6, the operations comprising: performing a ganged reset read operation on the first portion as the one or more memory operations.
Example 8. The system of Example 7, wherein performing the ganged reset read operation comprises: ramping up one or more word lines (WLs) without sensing a voltage associated with the one or more WLs in the first portion.
Example 9. The system of any one of Examples 6-8, the operations comprising: performing a dummy read operation on the first portion as the one or more memory operations.
Example 10. The system of any one of Examples 1-9, the operations comprising: selecting a second portion of the set of memory component; determining whether the second portion corresponds to the SLC usage; and selectively performing the one or more memory operations to prevent first page read errors associated with the second portion based on whether the second portion corresponds to SLC usage.
Example 11. The system of Example 10, the operations comprising: performing a ganged reset read operation on the second portion in response to determining that the second portion fails to correspond to the SLC usage; and skipping performing the ganged reset read operation on the first portion in response to determining that the first portion corresponds to the SLC usage.
Example 12. The system of any one of Examples 10-11, wherein the second portion corresponds to tri-level cell (TLC) or quad level cell (QLC) usage.
Example 13. The system of any one of Examples 1-12, the operations comprising: initiating performing a first page read errors scan operation in response to determining that the condition has been met.
Example 14. The system of any one of Examples 1-13, the operations comprising: transitioning a voltage threshold of the first portion from a stable state to a transient state in response to selectively performing the one or more memory operations.
Example 15. The system of Example 14, wherein the voltage threshold of the first portion returns to the stable state after a period of time elapses.

Methods and computer-readable storage medium with instructions for performing any one of the above Examples.

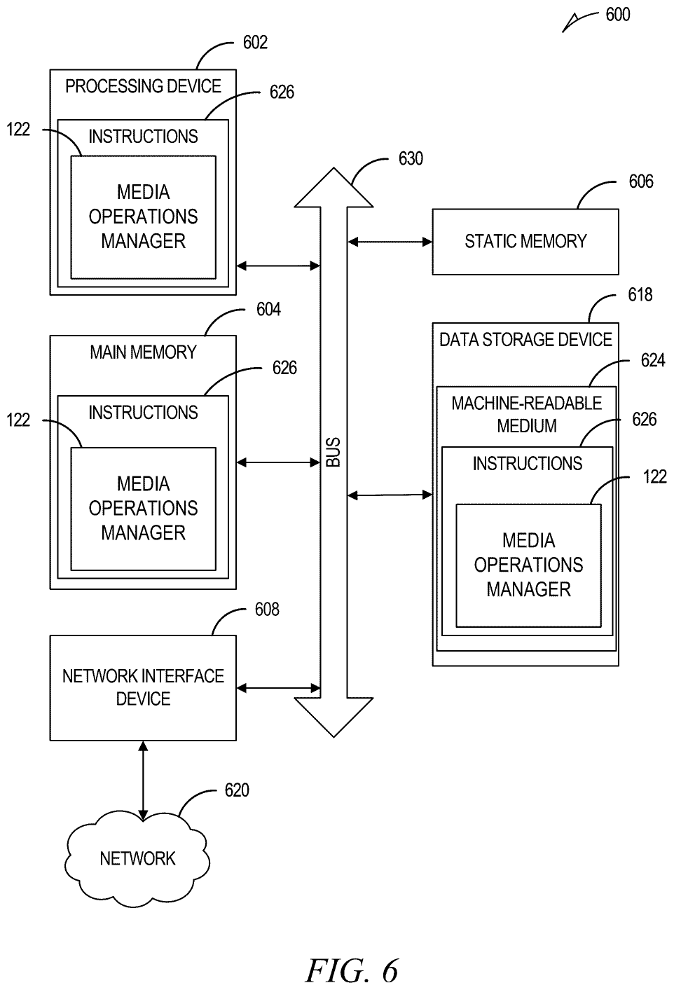

FIG. 6 illustrates an example machine in the form of a computer system 600 within which a set of instructions can be executed for causing the machine to perform any one or more of the methodologies discussed herein. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an application specific integrated circuit (ASIC), a field programmable gate array (FPGA), a digital signal processor (DSP), a network processor, or the like. The processing device 602 is configured to execute instructions 626 for performing the operations and steps discussed herein. The computer system 600 can further include a network interface device 608 to communicate over a network 620.

The data storage device 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage device 618, and/or main memory 604 can correspond to the memory sub-system 110 of FIG. 1.

In one embodiment, the instructions 626 implement functionality corresponding to the media operations manager 122 of FIG. 1. While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROMs); random access memories (RAMs); erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, embodiments of the disclosure have been described with reference to specific example embodiments thereof. It will be evident that various modifications can be made thereto without departing from the broader scope of the disclosure as set forth in the following claims. The specification and drawings are, accordingly, to be regarded in an illustrative sense rather than a restrictive sense.

What is claimed is:

1. A system comprising:
a set of memory components of a memory sub-system; and
at least one processing device operatively coupled to the set of memory components, the at least one processing device being configured to perform operations comprising:
determining that a condition to prevent first page read errors has been met;
in response to determining that the condition to prevent the first page read errors has been met, selecting a first portion of the set of memory components;
determining whether the first portion corresponds to single level cell (SLC) usage; and
selectively performing one or more memory operations to prevent first page read errors associated with the first portion based on whether the first portion corresponds to the SLC usage.

2. The system of claim 1, wherein the memory sub-system comprises a three-dimensional (3D) NAND memory.

3. The system of claim 1, the operations comprising:
accessing a timer associated with performing the one or more memory operations to prevent first page read errors;
determining that the timer transgresses a threshold value; and
determining that the condition has been met in response to determining that the timer transgresses the threshold value.

4. The system of claim 3, wherein the threshold value comprises a period of one or more minutes.

5. The system of claim 1, the operations comprising:
determining that the first portion corresponds to SLC usage; and
skipping performing the one or more memory operations on the first portion in response to determining that the first portion corresponds to SLC usage.

6. The system of claim 1, the operations comprising:
determining that the first portion fails to correspond to SLC usage; and
performing the one or more memory operations on the first portion in response to determining that the first portion fails to correspond to SLC usage.

7. The system of claim 6, the operations comprising:
performing a ganged reset read operation on the first portion as the one or more memory operations.

8. The system of claim 7, wherein performing the ganged reset read operation comprises:
ramping up one or more word lines (WLs) without sensing a voltage associated with the one or more WLs in the first portion.

9. The system of claim 6, the operations comprising:
performing a dummy read operation on the first portion as the one or more memory operations.

10. The system of claim 1, the operations comprising:
selecting a second portion of the set of memory component;
determining whether the second portion corresponds to the SLC usage; and
selectively performing the one or more memory operations to prevent first page read errors associated with the second portion based on whether the second portion corresponds to SLC usage.

11. The system of claim 10, the operations comprising:
performing a ganged reset read operation on the second portion in response to determining that the second portion fails to correspond to the SLC usage; and
skipping performing the ganged reset read operation on the first portion in response to determining that the first portion corresponds to the SLC usage.

12. The system of claim 10, wherein the second portion corresponds to tri-level cell (TLC) or quad level cell (QLC) usage.

13. The system of claim 1, the operations comprising:
initiating performing a first page read errors scan operation in response to determining that the condition has been met.

14. The system of claim 1, the operations comprising:
transitioning a voltage threshold of the first portion from a stable state to a transient state in response to selectively performing the one or more memory operations.

15. The system of claim 14, wherein the voltage threshold of the first portion returns to the stable state after a period of time elapses.

16. A method comprising:
determining that a condition to prevent first page read errors has been met;
in response to determining that the condition to prevent the first page read errors has been met, selecting a first portion of a set of memory components;
determining whether the first portion corresponds to single level cell (SLC) usage; and
selectively performing one or more memory operations to prevent first page read errors associated with the first portion based on whether the first portion corresponds to the SLC usage.

17. The method of claim 16, wherein a memory sub-system comprising the set of memory components comprises a three-dimensional (3D) NAND memory.

18. The method of claim 16, comprising:
accessing a timer associated with performing the one or more memory operations to prevent first page read errors;
determining that the timer transgresses a threshold value; and
determining that the condition has been met in response to determining that the timer transgresses the threshold value.

19. The method of claim 18, wherein the threshold value comprises a period of one or more minutes.

20. A non-transitory computer-readable storage medium comprising instructions that, when executed by at least one processing device, cause the at least one processing device to perform operations comprising:
determining that a condition to prevent first page read errors has been met;
in response to determining that the condition to prevent the first page read errors has been met, selecting a first portion of a set of memory components;
determining whether the first portion corresponds to single level cell (SLC) usage; and
selectively performing one or more memory operations to prevent first page read errors associated with the first portion based on whether the first portion corresponds to the SLC usage.
